(19) United States
(12) Patent Application Publication
(10) Pub. No.: US 2013/0249792 A1
(43) Pub. Date: Sep. 26, 2013

(54) SYSTEM AND METHOD FOR PRESENTING IMAGES

(71) Applicants: Gualtiero Carraro, Brescia (IT); Roberto Carraro, Palazzolo sull'Oglio (BS) (IT); Fulvio Massini, Cadelbosco di Sopra (RE) (IT)

(72) Inventors: Gualtiero Carraro, Brescia (IT); Roberto Carraro, Palazzolo sull'Oglio (BS) (IT); Fulvio Massini, Cadelbosco di Sopra (RE) (IT)

(73) Assignee: APP.LAB INC., Dover, DE (US)

(21) Appl. No.: 13/991,244

(22) PCT Filed: Dec. 1, 2011
(86) PCT No.: PCT/EP11/71520

§ 371 Date: Jun. 3, 2013

Related U.S. Application Data
(60) Provisional application No. 61/419,613, filed on Dec. 3, 2010.

(51) Int. Cl. G06T 15/00

(52) U.S. Cl. CPC G06T 15/00
USPC 345/156

(57) ABSTRACT

A system includes a mobile device having a display, a sensor, and a processor coupled to the display. The processor can be adapted to obtain three-dimensional (3D) imagery data, create a virtual container around the device according to the 3D data, calibrate the virtual container, select a first portion of an inner surface of the virtual container according to the calibration of the virtual container, present at the display a first image associated with the first portion, wherein the first image is derived from the 3D data, receive sensor data from the sensor, detect from the sensor data a movement by the device, select a second portion of the inner surface according to the detected movement, and present at the display a second image associated with the second portion, wherein the second image is derived from the 3D data. The 360° immersive image adapts to the position of the device.

### RELATED APPLICATIONS

This application is a 35 U.S.C. 371 national stage filing from International Application No. PCT/EP2011/071520 filed Dec. 1, 2011 and claims priority to U.S. Provisional Application No. 61/419,613 filed Dec. 3, 2010, the teachings of which are incorporated herein by reference.

### FIELD OF THE DISCLOSURE

The present disclosure generally relates to a system and method for presenting images. In particular, a system and method for presenting immersive illustrations for mobile publishing is also disclosed.

### BACKGROUND

Multimedia devices today can render images in two-dimensions (2D) or three dimensions (3D) depending on the application. For example, consumers can view 2D or 3D movies in movie theatres. 3D televisions are now available for viewing 3D TV programs or movies. Gaming consoles can present controllable video games in a 2D format with 3D perspectives. Mobile devices such as cellular phone, “smart” phones or mobile media players can present movies or games in a small form factor.

In the prior art, mobile devices having position and movement sensors are know. The sensor data can be used to change the image on the display of the device. For example, US2009/0325607 discloses a mobile device receiving from a remote server images captured from a location around the device. The images change automatically in response to user motion of the device. U.S. Pat. No. 6,222,482 discloses a mobile device providing information on closest features in a three-dimensional database by means of position data in a Global Positioning System (GPS). US2010/0053164 discloses two or more display components used to display 3D content where the images displayed are spatially correlated so that when a user moves one of the display he sees a different view of the 3D content displayed on the other components. WO2010/080166 discloses a user interface for mobile devices in which the device position/orientation in real space is used for selecting a portion of content to be displayed. The content is only a flat surface having dimensional size greater than that of the display of the mobile device. No immersive effect is wanted or obtained.

Unfortunately, the computing power of mobile devices available today is not sufficient to create and move in real-time 3D environments of great detail. However, for a truly immersive experience, a crucial point is the speed of response, i.e. the time passing between a movement of the device and the corresponding movement of the scene displayed on the device. This time is indispensable at the system for calculating the new 3D environment image and 3D environment movements require many calculations. When a movement does not appear simultaneous to the human eye between the device and scene displayed on it, the movement causes a total loss of 3D illusion of the immersive experience and confuses the user.

Various systems have been proposed for reducing the detail of the used image and for allowing a faster computation in a portable devices. The reduction of details, however, makes very artful images which are unsuitable for many purposes, such as the creation of truly immersive experience.

In “Pseudo-Immersive Real-Time Display of 3D Scenes on Mobile Devices”, Li et al., RWTH Aachen University, a client-server system is proposed, where the processing of the complex scene is performed on a server and the resulting data is streamed to the mobile device. However, the problem is the low bitrates of the data transmission and a complex scene geometry decomposition is required on the server and the image quality is decreased.

### BRIEF SUMMARY OF EMBODIMENTS OF THE INVENTION

It is a general aim of the present invention to allow on a mobile device also of type having relatively low computing power to view scenes also having high visual quality, with point of view movable by movement of the mobile device and with time response and display quality suitable to have a satisfying immersive experience for the user.

In view of the above aim, in accordance with the invention, are proposed a method, a device and a server as claimed in any one of the claims of the present invention.

### BRIEF DESCRIPTION OF THE DRAWINGS

For better clarifying the innovative principles of the present invention and the advantages it offers as compared with the known art, a possible embodiment applying said principles will be described hereinafter by way of non-limiting example, with the aid of the accompanying drawings.

It will be appreciated that for simplicity and clarity of illustration, elements illustrated in the Figures have not necessarily been drawn to scale. For example, the dimensions of some of the elements are exaggerated relative to other elements.

In the drawings:

FIG. 1 is a block diagram illustrating the device architecture in accordance with one embodiment of the present invention;

FIG. 2 is another block diagram of the device according to the invention;

FIG. 3 is a schematic view illustrating features of the method according to the invention;

FIG. 4 is an example of image usable in the present invention;

FIG. 5 is an schematic example illustrating the immersive image effect on a portable device according to the invention;

FIG. 6 is a schematic view illustrating how the 3D image data can be associated with the position of the mobile device;

FIGS. 7 and 8 are schematic views illustrating how 3D imagery data can be associated and used with location information of a mobile device;

FIG. 9 is a block diagram of the architecture of a networked system in accordance with an embodiment of the present disclosure;

FIG. 10 is a schematic example of how more users can share the 3D shape as “see what I see”;

FIG. 11 is a schematic view of a device that combines e-book data and immersive views according to the invention.

FIG. 12 shows an example of navigation in an immersive image displayed on a device according to the invention.

### DETAILED DESCRIPTION

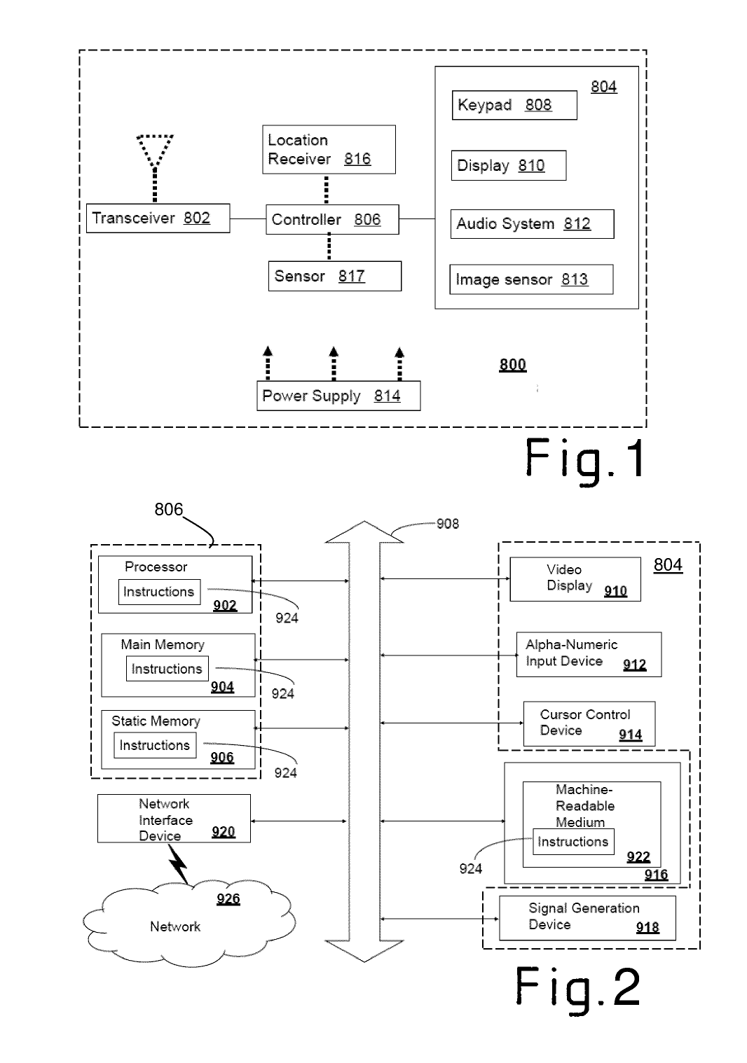

With reference to the figures, FIG. 1 shows schematically a mobile or portable device (generically referred as 800). The mobile device includes a display 810, a controller 806 and position sensor means 816, 817. As it will be further described below, memories for storing images to be returned to the display are also present (for example, in the controller itself). Advantageously, the device may include a user interface comprising the same display 810 designed as a touch-screen. The entire device can be advantageously contained in a substantially flat container with the display substantially carrying out a face of the container and suitable to be easily grasped with both hands, for example as shown in FIG. 5 (hand-held device).

The device can be a device specifically made or it can be a suitable known device programmable for various application and properly programmed to implement the invention, as it will be easily understands by the technician when he reads this description of the invention. For example, the device may be a tablet PC, a cellular phone, a smart phone, laptop, notebook, etc.

Dedicated hardware implementations including, but not limited to, application specific integrated circuits, programmable logic arrays and other hardware devices can likewise be constructed to carry out the portable device to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations. In any case, the mobile device will be of a type that a user can hold and move freely in real space, as it will be clear below.

The device 800 can also comprise a communication system which can be carried out by a wireline and/or wireless transceiver 802 (herein transceiver 802). Advantageously, the transceiver 802 can support short-range or long-range wireless access technologies such as Bluetooth, WiFi, or cellular communication technologies, just to mention a few. Cellular technologies can include, for example, CDMA-1X, UMTS/HSDPA, GSM/GPRS, TDMA/EDGE, EV/DO, WiMAX, SDR, LTE, as well as other next generation cellular wireless communication technologies as they arise. The transceiver 802 can also be adapted to support circuit-switched wireline access technologies (such as PSTN), packet-switched wireline access technologies (such as TCPIP, VoIP, etc.), and combinations thereof. The communication system of the device may enable the communication with other similar devices or a computer network for connecting the device to servers in order to obtain further information, new images or information for operating, as it will become clear below.

In addition to the display, the user interface (marked with 804 in the FIG. 1) can include a depressible or touch-sensitive keypad 808 with a navigation mechanism such as a roller ball, a joystick, a mouse, or a navigation disk for manipulating operations of the device 800. The keypad 808 also can be an integral part of a housing assembly of the device 800 or an independent device operably coupled thereto by a tethered wireline interface (such as a USB cable) or a wireless interface supporting for example Bluetooth. The keypad 808 can represent a numeric dialing keypad commonly used by phones, and/or a Qwerty keypad with alphanumeric keys. The technician can easy imagine all these devices and, therefore, they will not further described or shown here. The display 810 can be for example a monochrome or colour LCD (Liquid Crystal Display), OLED (Organic Light Emitting Diode) or other suitable display technology for conveying images to an end user of the device 800. In an embodiment where the display 810 is touch-sensitive, a portion or all of the keypad 808 can be presented by way of the display 810 with its navigation features, as may be easily imagined by the person skilled in the art.

The UI 804 can also include an audio system 812 that utilizes common audio technology for conveying low volume audio (such as audio heard only in the proximity of a human ear) and high volume audio (such as speakerphone for hands free operation). The audio system 812 can further include a microphone for receiving audible signals of an end user. The audio system 812 can also be used for voice recognition applications. The UI 804 can further include an image sensor 813 such as a charged coupled device (CCD) camera for capturing still or moving images.

Advantageously, the memory controller may contain and attach to the images a immersive audio corresponding to an area of the illustration. The audio may be a caption in form of voice, a sound effect, music or any text of audiobook which is spoken.

The content is activated when the user explores a specific area of the immersive image. The effect is an interactive surround sound, enjoyed by the user moving the device around, as it will be clear to the technician by the following description.

Advantageously, the device comprises also an suitable power supply 814. The power supply 814 can utilize common power management technologies such as replaceable and rechargeable batteries, supply regulation technologies, and charging system technologies for supplying energy to the components of the device 800 to facilitate long-range or short-range portable applications.

Advantageously, the position sensor means can comprise both a sensor 817 for detecting relative position and motion in the space (for example the rotation and/or acceleration along one or more axis) and means for detecting the absolute position of the device. Advantageously, the sensor 817 can comprise, for example, well-known motion sensors such as accelerometers and/or gyros for detecting motion in real 3D space and/or it can comprise at least one of a compass sensor, a location sensor, an orientation sensor. Advantageously, the means for detecting the absolute position of the device can comprise a location receiver 816 which can utilize common location technology such as a global positioning system (GPS) receiver capable of assisted GPS for identifying a location of the device 800 based on signals generated by a constellation of GPS satellites, thereby facilitating common location services such as navigation.

Moreover, the sensors can also comprise environmental sensors. Such sensors can comprise at least one of a light sensor, a temperature sensor, and a barometric sensor. For example, this may allow, as it will become clear below, to change the displayed images depending on environmental conditions (e.g. day-night, hot-cold, etc.) so as to be able to adapt the virtual experience to real environmental conditions.

The controller 806 can utilize computing technologies such as a microprocessor, a digital signal processor (DSP), and/or a video processor with associated storage memory such a Flash, ROM, RAM, SRAM, DRAM or other storage technologies. For example, a disk drive unit can be also provided.

The general architecture of such a controller is per se well known and easily imaginable by the technician. Therefore, it is not further described or shown herewith.

In FIG. 2 it is shown schematically in more detail a possible structure of the device 800 with the controller 806 including a processor 902, a main memory 904 and a static memory 906, and in which the transceiver 802 performs a network interface device 920 for network 926, the user interface 804 includes a display 910, an input device 912, a cursor control device 914 and a signal generation device 918. A disk drives 916 may also be present. All or part of the various elements can be connected to each other by a bus 908.

When the device is made in the form of a computer system within which a set of instructions, when executed, may cause the machine to perform any one or more of the methods according to the invention, an high flexibility of use is obtained.

The disk drive unit 916 may include a tangible computer-readable storage medium 922 on which is stored one or more sets of instructions (e.g., software 924) embodying any one or more of the methods or functions described herein, including those methods illustrated above. The instructions 924 may also reside, completely or at least partially, within the main memory 904, the static memory 906, and/or within the processor 902 during execution thereof by the computer system. The main memory 904 and the processor 902 also may constitute tangible computer-readable storage media.

The term “tangible computer-readable storage medium” shall also be taken to include any medium that is capable of storing, encoding or carrying a set of instructions for execution by the machine and that cause the machine to perform any one or more of the methods of the present disclosure.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium or a tangible distribution medium, as listed herein and including art-recognized equivalents and successor media, in which the software implementations herein are stored.

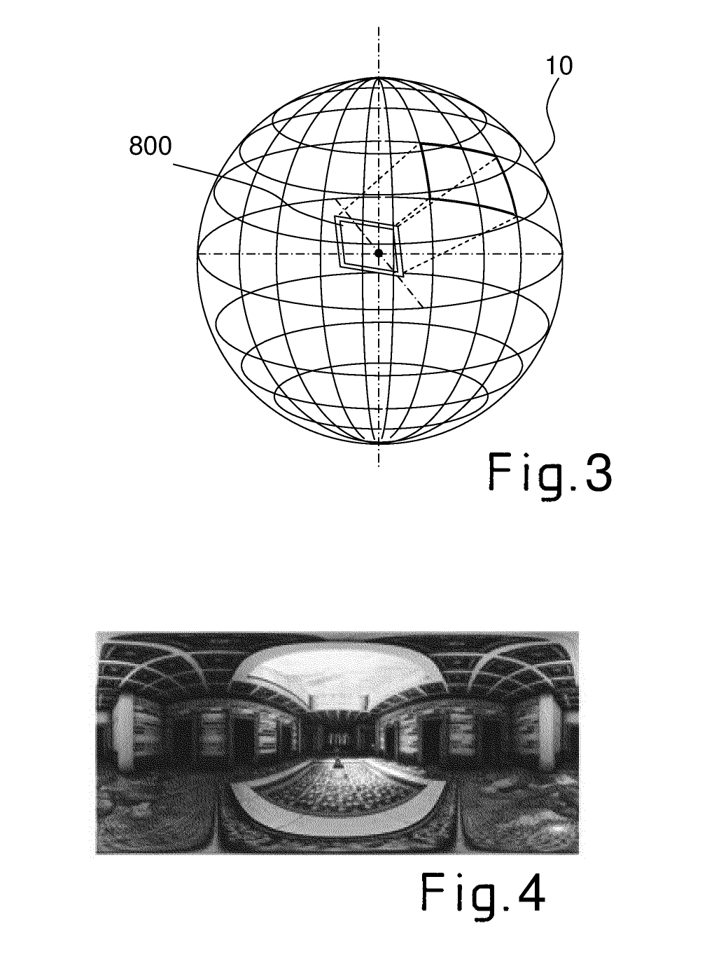

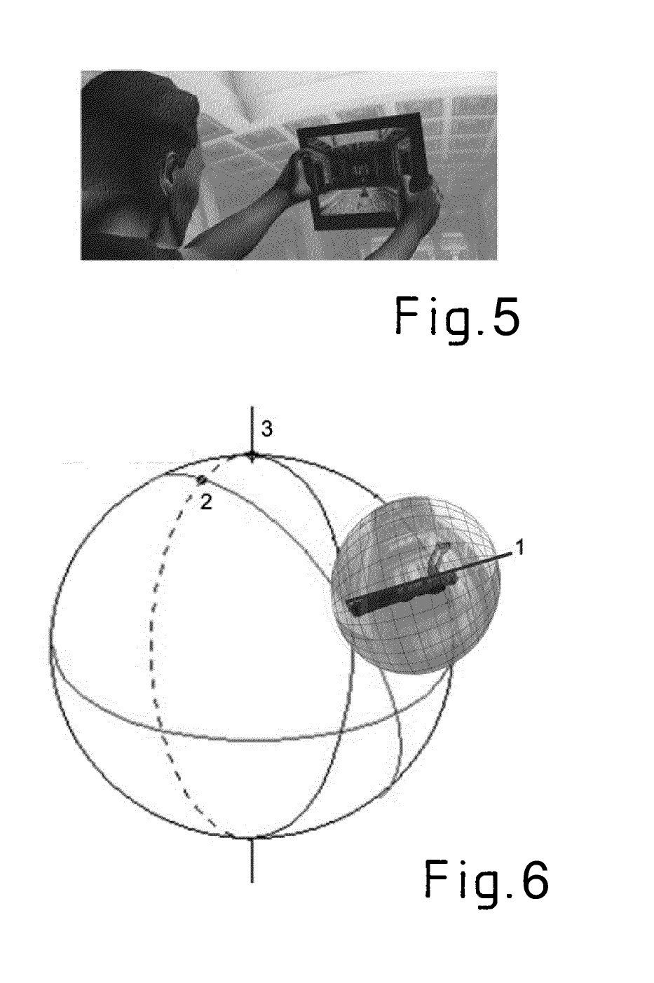

In any case, as it shown schematically in FIG. 3 (which is also a magnification of a element of FIG. 6), according to the method of the present invention it is produced a “virtual bubble” or virtual space container 10. As it is further described below, image (which is previously shot or synthetically rendered) is related to the inner surface of the bubble. The image processing and its correlation with the surface of the “bubble” can be performed off-line on a computer with adequate computing power by means well-known graphics processing methods. As it is understandable from FIG. 4, the image related to the bubble will be distorted appropriately advantageously in the plan, so as to be a substantially undistorted view when “applied” to the inner surface of the bubble. In particular, the image is advantageously a essentially static image. The image in substantially in form of a imagery data. The imagery data can be also obtained from one database structure (local or remote, as it will be clear below).

After that the imagery data of the virtual environment has been obtained with the chosen acquisition and/or processing system, a virtual container around the mobile device according to the 3D imagery data has been created and the images of the virtual environment has been correlated on the inner surface of a virtual container, the virtual container can be calibrate around the mobile device, so that a user with a mobile computing device is in the centre coordinates of a virtual 3D shape (the shape may be a cube, cylinder or, more advantageously, a sphere). Such shape can be displayed on the screen of the mobile device as the device screen is a window that frames a part of the inner surface of the virtual form. For example, this is evident from FIGS. 5 and 6. In the following, we will refer to a sphere, which is especially helpful to have an uniform immersive experience during the movements of the device.

The rendition of the content on the mobile device can be computed quickly by the mobile device on the basis of the sensor data collected from the device. Exemplary cases of sensors are accelerometer and compass sensors.

In an embodiment the sensor data includes GPS or other coordinate information system. Thanks to the sensors, the position coordinates sensed in the mobile device change as the user moves the mobile device or moves with the mobile device. In this manner, the system can re-compute in real time the new content projection on the 3D shape and renders it on the mobile device display. By moving the mobile device the user can explore and interact with the rendered content.

In other words, the device selects for the visualization a first portion of an inner surface of the virtual container according to the calibration of the virtual container and presents at the display a first image associated with the first portion of the inner surface of the virtual container, wherein the first image is derived from the 3D imagery data. This is clearly shown in FIGS. 3 and 4. The controller of the device receives data from the sensor means when the device is moving (usually by turning it up, down, left or right) and it computes from such data the corresponding movement in the real space, selects a second portion of the inner surface of the virtual container according to the detected movement, and presents at the display a second image associated with the second portion of the inner surface of the virtual container, wherein the second image is also derived from the 3D imagery data.

Due to the fact that the displayed images are actually two-dimensional static images the visualization speed is very high also on the relatively limited computational power device and the movement is almost instantaneous (in the sense that the user does not notice a time difference between the actual movement of the device and the virtual movement of the image on the display. The fact that the displayed image is related to a virtual bubble around the device, it is found to provide a truly high feeling immersive experience and the user has the sensation that the environment, which he sees on the display, is a real three-dimensional environment. The fact that the image can be a high quality image (and also it may be a off-line processed photograph of the real world) contributes to the illusion.

In other words, the mobile device (4) can collect, filter and normalize sensor data coming from sensor hardware on the device. On this basis it computes the 3D rendition by processing content which is stored on the device and projects it onto a virtual 3D Shape. In this specific embodiment the orientation on the vertical axis is computed from the accelerometer data and the orientation on the horizontal one from a compass (3). The software application running on the mobile device computes the projection of the input content on a virtual 3D sphere where the mobile device and the user are in its centre and displays on the device screen.

The apparent dimension of the sphere can be prefixed or resulted from the environment to be represented (for example, according to well-known rule of perspective projection) and in this manner the system can also allow to accommodate different processing components on the 3D projection, e.g., controlling the level of zoom on which the content is rendered affecting the proportion and the visual distance of the 3D virtual environment around the mobile device.

Advantageously, data (sensed by the sensors for controlling the visualization) can comprise at least one of distance travelled, acceleration, velocity, and a change in 3D coordinates.

FIG. 6 is a block diagram illustrating the 3D projection of the content n accordance with an embodiment of the present disclosure. The 3D projection of the content is computed on the basis of the sensor data. The resulting virtual 3D environment is locked to the vertical axis Up-down (1) and to a cardinal point such as the magnetic north pole (2).

In one embodiment of FIG. 6 GPS data is available among the sensor data and the cardinal point used is the geographic (3) to allow the horizontal orientation.

In this way, the virtual bubble can be calibrated as well as to be centered with the device also to be rotated correctly for example as regards to the real space, so that the image which we seen through the device is spatially oriented as to real space.

Generally, an user can be still or in movement (i.e. walking) and the 3D shape presented by the system moves with the user. In case of use of GPS sensor, the user's movement can be also interpreted for changing the visualization according to the location.

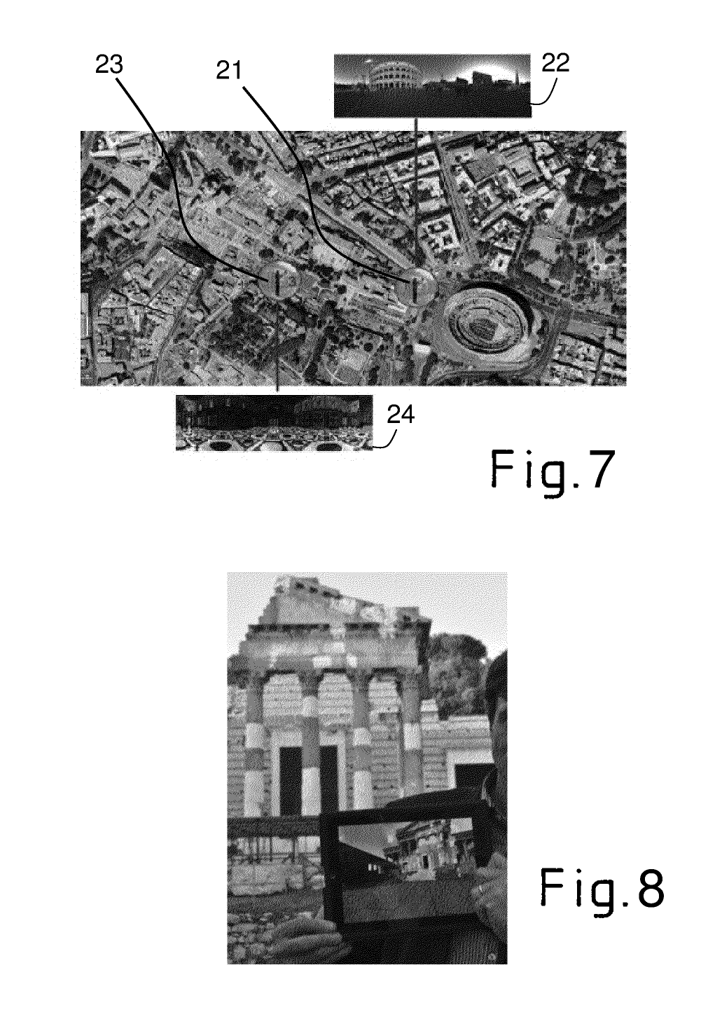

For example, FIG. 7 schematically depicts applications where the GPS information is used to enable the device position is mapped to the coordinates of a geographical location and a specific 3D image is selected to represent that area. In the example a map of downtown Roma is shown. When the user is, for example, in piazza del Colosseo (21) the device collects the GPS data and “projects” the corresponding image (22) at 360 degrees by means of the virtual bubble. Such image can represent for example the old appearance of the roman amphitheatre. If the user and the device moves to a different point, i.e. for example in the Aula Regia del Palatino (23) the system “projects” on the bubble the image of the reconstruction of the interiors of the imperial palace (24). In this embodiment for a given geo-reference it is possible by means of this invention to render a timeline that shows how that geo-reference changed in time and can be represented in the future.

For example, when location information is part of the sensor data if the user is in an archaeological site where the 3D projection is mapped on the corresponding location coordinates, then the 3D reconstruction shows the original appearance of the archaeological site. This is schematically depicted by example in FIG. 8.

In other word, we can also obtain an insertion of overlapping layers and, for example, in the case of an image of an urban environment, we can see the picture of a square as it is in the present condition, but also activate a second superimposed picture which shows the aspect of the same square in the past or future.

In the movement, a travel distance threshold can be provided so that exceeding such threshold the image is replaced with another. Advantageously, we can think to obtain a new data set of 3D imagery data responsive to the detected movement indicating that the mobile device has exceeded a travel distance threshold, and repeat the creating, calibrating, selecting, presenting, receiving and detecting steps with the new data set of 3D imagery data.

It should be noted that the system according to the invention can be self contained in the mobile device which collects the sensor data, computes the rendition and renders it on the mobile device display, without need of external communication apart from GPS positioning in the real space (if used).

Alternatively, sensor data can be transmitted from the mobile device to a remote server via a communication network which processes the sensor data generates the corresponding content and streams it over a wireless communication network to the device. This may allow to change the views, download a new views, add variable information to them or synchronize the views on several devices

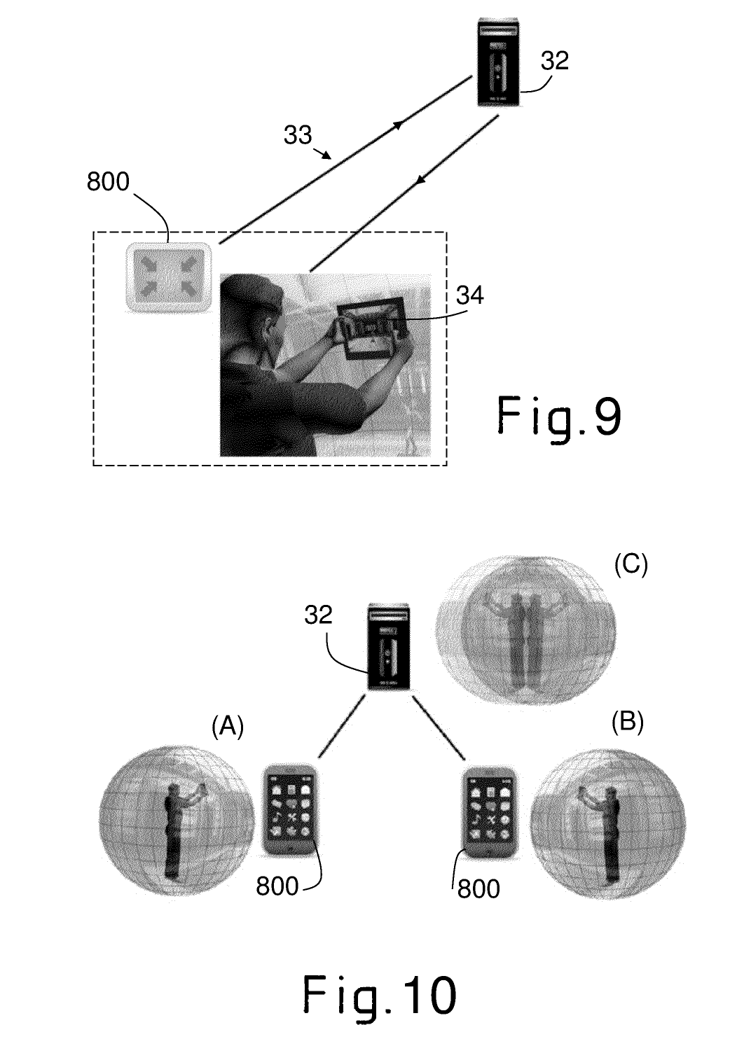

FIG. 9 is a block diagram the architecture of the networked system in accordance with an embodiment of the present disclosure. Sensor data is transmitted from the mobile device (1) to remote servers (2) via a computer network (3) which processes the sensor data, generates the corresponding content (4) and streams it over a computer wireless network to the device (obviously, the same computer network with wireless access can be employed in both directions).

In one embodiment of FIG. 9 user profile information residing on a remote server can be used to identify the user, the interaction that the user can have with the device and the processing (content and sensor data) to be performed.

In one embodiment of FIG. 3 the content is not stored locally but resides on a remote content server. It will be clear to the technician that in a networked system the content may not be initially stored locally on the device 800, but reside on a remote server content, if it is desired. Because we have to transfer only data of the flat image, the amount of data to be transferred is still low enough. The image data, once received, can be temporarily stored in the device 800 for the correlation with the virtual bubble and the visualization according to the movement of the device.

The sensor data processing and the content processing can be shared among the network servers and the device.

All the communication between device and the network can be encrypted for security.

Moreover, in one embodiment of the system with the network an apparatus system can create a ‘personal’ view of the content based on personal preferences and a user profile that can be stored locally on a device or on a network.

Advantageously, the system can also dynamically add active areas called “hotspots” in the rendered imagery as well as the dynamic insertion of multimedia elements in the rendition on the basis of the sensor data. Examples of these elements are directional audio, 3D animations, video. These additions can be easily handled by the controller (in a per se well-known way that a technician can easily imagine from the herewith description) and included in, or come from, the memory of the device.

As it will be clear below, the user can interact with a mobile device display and leave a personal annotation on the 3D rendered content. These annotations can be inserted easily by the user through input mode that will be clear from below (e.g., by using the user interface).

If the system is networked, hot spots and annotations can also be dynamically transmitted over the network, besides locally present in the device memory.

Thanks to a system connected to a network, multiple users, each with its own device 800, can interact with each other. FIG. 10 shows how different users with mobile device can for example ‘merge’ their viewing experience (“you see what I see”) (C). One user (A) can interact with a remote user (B) by interacting with its remote 3D shape, for example through a network server or directly, if preferred and/or possible for the wireless transmission system used. In any case, once established wireless communications with a second device, it is possible to share with the second device images associated with portions of the inner surface of the virtual container as the images are presented at the display of the mobile device. In this manner, it is possible for example transmit to a second device the images to enable the second device to present at a display of the second device substantially the same images presented by the other mobile device.

For example, in one embodiment of FIG. 10 the individual views can be shared over a social network in stored form or in real time.

In one embodiment the 3D rendition can be recorded, stored, transmitted and shared via social networking (“you can see what I saw”).

The timeline of the projection (i.e. what the user saw, how he interacted with the projection, the type of projection he choose, etc., or in other words the user experience in interacting dynamically with the 3D shape) can be also saved and edited and published and replayed by other users.

These features are possible thanks to the low amount of image data which is necessary to exchange, by virtue of the immersive reality “bubble” method according to the invention.

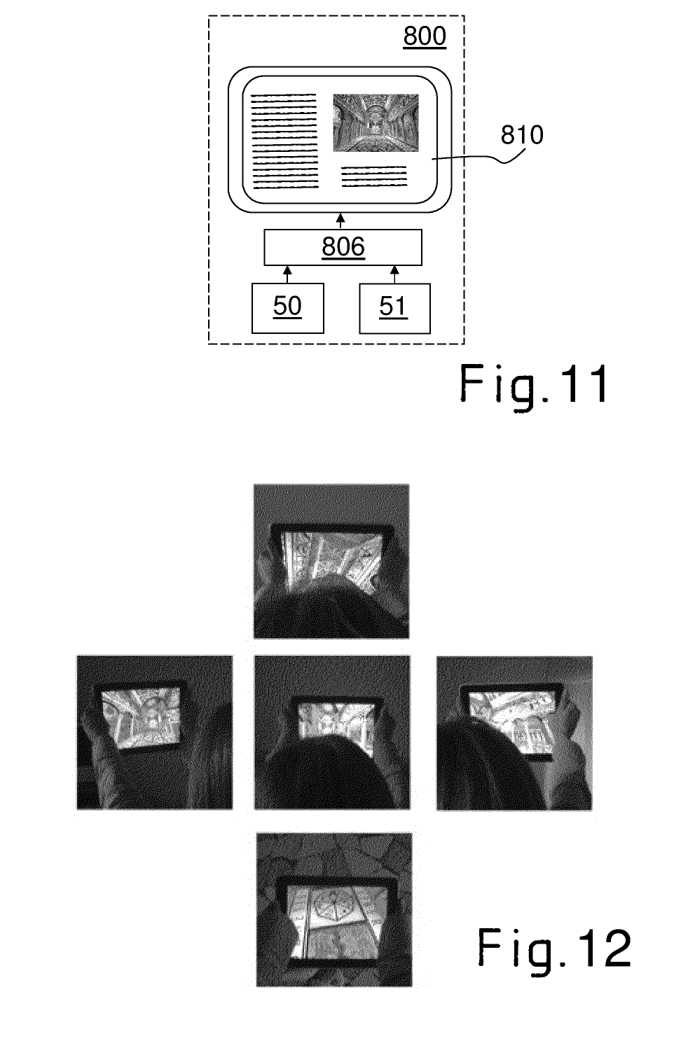

There are several applications that can take advantage of the “bubble” method of the present invention. For example, it is particularly advantageous use in the field of electronic publishing. Thanks to the principles of the invention, from a displayed 2D page we can move to a 3D world that can be explored according to the embodiments of the present invention. In FIG. 11 it is shown in more detail a possible embodiment, however evident from the description above already made.

The device 800 advantageously has memory (or source) of content that is divided (logically or physically) in a memory or source of “e-book” content 50 and a memory or source of content for displaying 3D immersive images as described above.

In this and other embodiments of the present invention, the content types range from static natural or synthetic pictures to natural or synthetic video to synthetic imagery.

In particular, according to the principles of the invention described above, it is feasible an immersive publishing, i.e. we can page and publish three-dimensional content in immersive environments created by images at 360° in mobile devices. “Immersive publishing” is defined as a work that combines text or multimedia content to the use of 360° images which may be defined as “immersive illustration”.

From the application point of view, the immersive illustration is an three-dimensional element which is inserted in a digital publication, such as an e-book, an APP or a catalog.

As the user reads the publication, the user can switch between linear two dimensional use of the content (for example, as shown in the upper of FIG. 11) and a immersive use of content with navigation by means of movement of the mobile device.

Traditional reading posture, with the device horizontally and down, remains the basic position for the publishing industry, even in mobile devices. The present invention adds to this posture the vertical viewing, modifying the image in the device and provides an immersive version and 360°

With the present invention a multimedia publication is transformed into an immersive publication. The traditional reading experience, performed by holding the device horizontally and downwards, is enriched by an immersive experience that places the reader in an image 360 degrees around him, when the reader picks up the device and places it upright.

In other words, it is possible to receive and/or store e-book content in the mobile device with a object end/or the imagery data embedded therein, detect a selection of the object in the e-book, obtain the imagery data responsive to the detected selection; and adapt the presentation of the imagery data according to the virtual container and sensor data detected by the mobile device. The object can comprise at least one of an image or selectable text.

For example, the user can scroll the text 52 having an associated static FIG. 53. When the user sees the figure, the user can “dive” in the figure by start of the immersive visualization mode. The selection of the figure for the passage in immersive mode can be done in various ways, for example employing the user interface described above, as it is now easy to imagine by the technician.

Advantageously, the selection of content within the immersive illustration can also be done pointing the device physically toward an area of the image, using a “informative foresight”. When the user has rotated the device to merge the foresight to a specific area of the image, such area becomes active and a text, visual or sound content is published. This mode of operation has some functional similarities with augmented reality, but it differs significantly from this because the image is not derived from a camera, so it is not the image of the real environment around the user, but it is a image of the virtual environment created with off-line technologies, such as photographic or 3D Computer Graphics technologies. The area of the 360° image which is pointed by the user, may be made evident using various methods (appearance of a title, color, lighting, feedback of a foresight, mechanical feedback as a vibration, etc).

The informative foresight may be advantageously autonomous in respect to a touch interface so that it does not require a touch on the screen, although it may foresee it as an additional mode of interaction.

In fact, the hands are generally employed in the physical movement of the device, so that the activation of information is mainly driven by the displacement of the framing.

Moreover, we can think to enable the selected area with the foresight using the time of the foresight on the selected area: after that the foresight has been moved to an area of interest, his stay in that area for a prefixed time active the visualization or function assigned to the area.

The activable areas may also be formed by hot spots as already described above.

Moreover, the switching between “e-book mode” and “immersive mode” can be also performed in an automatic manner, by the movement of the device between the substantially horizontal “e-book” basic position and the immersive navigation position, when the reader picks up the device and places it upright.

The device according to the invention may also include a further innovative feature when e-books content and immersive visualization as described above are used.

In fact, usually we read a mobile device, such as a tablet or a smartphone in a horizontal or slightly inclined position of the screen. This is particularly evident in a “Lean Back” posture (for example, reading on a couch) but it also happens when we read a text standing on, or when the smartphone or tablet rests on a table or lectern.

This ergonomic condition means that when an user switches from the two-dimensional reading to immersive illustration, and then he activates the image mapped as a 3D bubble, he is looking at the floor of the image.

Obviously, in any real or virtual environment usually the ground-floor is free of visual and informative items, useful or otherwise significant. Hence it is relevant the risk that the user has a disappointing first impact in the transition from 2D to 3D, and he not perceive the meaning and content of immersive illustration.

According to the invention, therefore, several graphic elements can be introduced in the immersive image, placed on the floor (or in non-interest image areas) to signal the need for the user to turn up (in the case of a floor) the mobile device so as to move the device for displaying at least a frontal area of the image. These graphic elements can be “horizontal indexes” or “floor maps” and they solve the above mentioned ergonomic and informative shortcomings, by the insertion of immersive graphics signals in the lower section of the image.

In addition to a simple arrow indicator, these graphic elements may take the form of a map, for example in which the location—with respect to the cardinal axes—of the interesting elements present and navigable in the image are reported. Alternatively, a three-dimensional index can be created, which projects some notices (in perspective from above) on different sides.

In FIG. 12 the five pictures depict a user as s/he is moving the mobile device around him/herself in 5 directions. In this particular example a 3D image of a building (church) has been used. The user looks at the 3D image as spherical projection around him. In the top image the ceiling has been rendered and on the bottom one the floor. In the central picture a “central” representation of the church is shown. In the left and right picture the lateral church ‘navate’ are shown.

The displayed virtual images correspond to the direction up, down, right and left of the device in the real world. In the case of publishing with immersive views, such as shown in FIG. 11, the view of the e-book content can include the static image of the central area of the church. Once we have selected the static image, the device activates the immersive mode of FIG. 12.

As mentioned above, if the user was reading the e-book content with the device turned down, he may find himself staring at the floor. As it shown schematically in FIG. 12, the display of the floor (lower image) can show a map or an indicator (arrow or notice) that suggests to the user to lift the device, so as to pass at least to the visualization shown in the central image of FIG. 12.

The indicators can be placed directly at the time of its creation off-line image that is mapped on the bubble. Alternatively or in addition, elements can be stacked easily indicators from the image controller 806 in real time. Indicators can only appear as such to the shift from viewing e-books to immersive visualization and not during the subsequent normal navigation immersive.

Moreover, the 360° immersive image can adapt to the position of the device; when it is turned down, for example, it can display a map of the immersive environment, and when it is directed vertically, the environment appears in perspective mode for virtual navigation as above disclosed.

As already mentioned above, the contents of the image can also be associated with immersive audio. If such an interactive catalog, you can imagine in an immersive environment catalog with products (such as a furniture showroom) in which a descriptive caption for each piece of furniture is read aloud when the product is framed by ‘user.

As already mentioned above, you may also advantageously provide that the user can insert additional notes or references.

At this point it is apparent that the intended purposes are achieved.

It should be noted that a mobile device according to the invention is not physically constrained in any manner as is the case for virtual reality systems that exist today. That is, the present invention contemplates that methods described herein can be used by a mobile device to depict images from inner surfaces of a virtual container at anytime and anywhere on Earth without tethering the mobile device to cables, or physically constraining movement of the mobile device by an apparatus which limits the movement of a user carrying the mobile device to a closed area such as a physical sphere, closed room, or other form of compartmentalization used in virtual reality systems.

The use of the present invention can be advantageous in many different fields, as in particular the exploration of the internals of a car, virtual guides in outdoor or indoor environments, museum (while in a museum room I can explore related content according to the embodiments of the present disclosure, or in alternative way to navigate a museum), gaming, medical applications, etc.

Obviously, the above description of an embodiment applying the innovative principles of the present invention is given by way of example only and therefore must not be considered as a limitation of the scope of the patent rights herein claimed. For instance, although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth, WiFi, Zigbee), and long-range communications (e.g., WiMAX, GSM, CDMA) are contemplated for use by computer system 900.

By way of example, and without limitation, data transport media may include wired media, such as a wired network or direct-wired connection, and wireless media such as acoustic, RF, infrared or other forms of wireless media.

In addition, the portable device can be carried out with other devices and elements per se well-known and easily imaginable by the technician, and which can be appropriately programmed or adapted to perform the method of the invention. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Thank to the its flexibility the system can manage a variety of content formats.

Exemplary cases are 3D raster images, 360 degrees panorama images, QTVR and CAD vector imagery, etc.

Obviously, the system may include other facilities for the user, as now easily understandable for the technician on the basis of the present description of the principles of the invention.

For example the system can process the data according to a locally stored set of user preferences.

Moreover, the system can process the data according to a set of visual filters (i.e. colour modifications to compensate for colour blindness, or user selectable visual filters, i.e. different illumination schemes of the scene).

In one embodiment, content can be manipulated while it is rendered by a device.

Examples are zooming to see the details of what is displayed, or “personalized” filters.

In one embodiment, content can be also manipulated to compensate for viewer challenges: colour blind people may get a different view of the content with altered colours, the content rendition can be adapted to the viewer (i.e. a kid may have a different rendition of the content than what is presented to an adult when pointing at the very same position).

1. Method for presenting virtual 3D images on a display of a mobile device, the mobile device comprising the display, a position sensor means and a controller coupled to the display and the position sensor means, the method comprising the steps of
obtaining imagery data;
creating a virtual container around the mobile device;
correlating the imagery data to an inner surface of the virtual container.
selecting a first portion of the inner surface of the virtual container;
presenting at the display a first image associated with the first portion of the inner surface of the virtual container, wherein the first image is derived from the imagery data;
receiving sensor data from the sensor means;
detecting from the sensor data a movement by the mobile device relative to real space;
selecting a second portion of the inner surface of the virtual container according to the detected movement; and
presenting at the display a second image associated with the second portion of the inner surface of the virtual container, wherein the second image is derived from the imagery data.

2. Method according to claim 1, wherein the virtual container corresponds to one of a sphere, a cylinder or a cube.

3. Method according to claim 1, wherein the mobile device is one of a tablet, smart phone or cellular phone.

4. Method according to in claim 1, wherein the sensor means comprise an absolute positioning sensor, and the imagery data is associated with a location of the mobile device.)

5. Method according to claim 4, wherein the absolute positioning sensor comprises a global positioning system receiver for processing signals from a constellation of satellites.

6. Method according to claim 1, wherein the detected movement comprises at least one of distance travelled, acceleration, velocity, orientation and a change in 3D coordinates.

7. Method according to in claim 1, wherein the mobile device comprises a wireless communication device, and wherein an adaptation of the imagery data presented by the mobile device with at least one other mobile device is shared by way of a communication network.

8. Method of claim 1, further comprising the steps:
receiving or storing e-book content in the mobile device with an object embedded therein;
detecting a selection of the object in the e-book content;
obtaining the imagery data responsive to the detected selection; and
adapting the presentation of the imagery data according to the virtual container and sensor data detected by the mobile device.

9. Method of claim 8, wherein the object comprises at least one of an image and selectable text.

10. Method of claim 1, wherein the sensor data comprises at least one of a cardinal point of a compass, a location coordinate, an orientation, and environmental data.

11. Method of claim 1, wherein the processor is adapted to obtain the imagery data according to a location of the mobile device determined from sensor data derived from the sensor, and wherein the first and second images emulate at least in part environmental images in a vicinity of the mobile device.

12. Method of claim 1, wherein the imagery data is obtained from one of a local database or a remote database.

13. Method of claim 1, wherein the virtual container is calibrated to a predetermined image reference.

14. Method of claim 1, wherein the virtual container is calibrated to sensor data.

15. Method of claim 1, wherein sensor data is transmitted from the mobile device to at least one of a remote server and other mobile device via a computer network which processes the sensor data, generates corresponding content, and streams the data over a computer wireless network to the device.

16. Method according to claim 1, wherein the mobile device comprises memory wherein exists exist a source of “e-book” content having selectable objects and a source of content of imagery data for displaying immersive images, and immersive images are displayed when said selectable objects are selected.

17. Method according to claim 1, wherein the mobile device comprises memory wherein exists a source of “e-book” content and a source of content of imagery data for displaying immersive images, and wherein switching between an “e-book mode” and an “immersive mode” is performed by movement of the mobile device between a substantially horizontal “e-book” basic position and an immersive navigation position when the device is picked up and placed upright.

18. Method according to claim 16, wherein in the immersive images are graphics elements which are placed on floor areas of the immersive images to signal a need to turn up the mobile device.

19. Mobile device comprising a display, position sensor means and a controller coupled to the display and the position sensor means for displaying images on the display according to the position sensor means according to the method of claim 1.

20. Mobile device according to claim 19, comprising a memory logically or physically divided in a memory or source of “e-book” content and a memory or source of content for displaying immersive images, and comprising switching means for switching between “e-book” content and immersive content for displaying immersive images.

21. A server adapted to receive from a mobile device according to claim 19 a request for imagery data; transmit to the mobile device the imagery data, wherein images derived from the imagery data are associated with portions of an inner surface of a virtual container created around the mobile device and portions of the inner surface of the virtual container are selected by the mobile device according to sensor data; and images associated with the selected portions are presented by the mobile device.
